(19) United States
(12) Patent Application Publication
(10) Pub. No.: US 2018/0049586 A1
(43) Pub. Date: Feb. 22, 2018

(54) PORTABLE ROTATING SPIT WITH REMOTE TEMPERATURE MONITORING

(71) Applicant: BOUCLE - IMPORTAÇÃO E EXPORTAÇÃO LTDA - ME., Porto Alegre - RS (BR)

(72) Inventor: Fábio ABENSUR, Porto Alegre - RS (BR)

(21) Appl. No.: 15/680,789

(22) Filed: Aug. 18, 2017

(30) Foreign Application Priority Data
Aug. 19, 2016 (BR) 10 2016 019229 3

(51) Int. Cl. A47J 37/04

(52) U.S. Cl. CPC A47J 37/041

(57) ABSTRACT

A portable rotating spit for grills including a blade mounted on a cylindrical support in which the electronic device is installed. A bearing engages the support and is screwed into a ring which is threaded into the thread of the rotating assembly of the blade of the spit. A cover of the handle is threaded into the opposite segment of the thread of the rotating assembly. The rotating portion of the spit includes the blade mounted on the support and integrated by a probe with a weld bead and a wire pack for the thermocouples which will measure the temperature points of the food in contact with the spit. The printed circuit board of the electronic device and a disc with a central hole, in which the shaft of the gearmotor is fitted, are attached to the support. The rotating assembly of the blade includes a housing receiving the batteries, a gearmotor, a switch and a washer. The electronic device has an electric source with batteries, a microprocessor which receives the signals from analog/digital converters which are interconnected to the thermocouples attached to the blade of the spit and a Bluetooth module enabling a wireless transmission to the application installed on the smartphone.

### CROSS-REFERENCE TO RELATED APPLICATION

The present application claims priority to Brazilian Patent Application No. BR 10 2016 019229 3, filed Aug. 19, 2016, the content of which is incorporated herein by reference.

### INTRODUCTION

This invention is an innovative portable rotating spit for grills in general, having temperature sensors integrated in its blade and which are interconnected to an electronic device built into its handle which executes the wireless transmission to an application installed on a smart intended to monitor the temperature of the food.

### BACKGROUND OF THE INVENTION

Rotating spits already known in the market provide an automatic and continuous rotation of your blade, but do not control cooking time or cooking stage of the food. Thus, to roast food in a rotating spit requires experience and attention; otherwise, the food may be raw (rare stage) or burned (beyond the well done stage).

There are methods for measuring the temperature of the food to be roasted on a rotating spit, but all of these methods require that the rotating motion of the spit be stopped to penetrate a thermometer probe into the food. There are other methods enabling the probe with thermometer to be kept inside the food being roasted, but they are not applicable to rotating spits.

The rotating barbecue spits already known in the market comprise an electric motor with a speed reducer which are mounted inside the handle, causing the rotation of the blade in which the food is skewed. In order to prevent the movement of the handle, it has means for seating and immobilizing the structure of the grill. Examples of rotating spits are described in the following patent documents: BR MU 6900384, BR MU 7600282-9, BR MU 8402123-3, BR MU 8900968-1, BR MU 8902672-1, BR 20 2012 006800-7 and BR 20 2013 016058-5. However, these rotating spits do not have temperature sensors, not enabling the control of food cooking stage.

The document U.S. Pat. No. 6,546,846 discloses a spit with temperature sensors on the blade, having a thermometer in the handle for temperature indication. However, this is a simple spit; in other words, it does not have means enabling a self-rotation and, therefore, it can only be used in rotisserie grills with a specific mechanism for rotating the entire device. Another disadvantage of this spit is that it does not have the means to monitor the temperature, as well as send an alert signal when the desired temperature is reached. Another disadvantage of this spit is that it requires the user to be near the rotisserie grill and constantly watch the thermometer to check the temperature reached at that time.

The document U.S. Pat. No. 6,539,842 also discloses a spit without self-rotating means and which can only be employed in rotisserie preparations with a specific mechanism of rotation of the spit. Another disadvantage of this spit is that it has a complex construction, partially tubular, which requires a special ring with forks provided with temperature sensors. This spit enables the remote monitoring of temperature, without the user being near the rotisserie grill to observe the thermometer and check the temperature reached at that time. However, a specific electronic device is required for this monitoring.

The document US 2015/027321 also discloses a spit without self-rotating means and which can only be employed in rotisserie preparations with a specific mechanism of rotation of the spit. Another disadvantage of this spit is that it has a complex tubular construction with a probe that must be introduced into the food to be roasted. This spit enables the remote monitoring of temperature, without the user being near the rotisserie grill to observe the thermometer and check the temperature reached at that time. However, a specific electronic device is required for this monitoring.

### SUMMARY OF THE INVENTION

Therefore, an object of the present invention is an innovative portable rotating spit for grills in general, having temperature sensors integrated in its blade which are connected to an electronic device built into its handle processing the data and executing the wireless transmission to an application installed on a smart intended to monitor the temperature of the food.

The handle of the spit is hollow and houses a battery pack inside feeding a gearmotor whose shaft is inserted in the hole of a disc attached to the support of the blade of spit. The support slides rotatably into a bearing which is attached at the forward end of the handle so that the handle is static while the blade together with the support, the printed circuit board and the disc are rotatable. A switch installed in the free end of the handle enables the interconnection of the batteries to the printed circuit board.

The electronic device comprises a printed circuit board with an electric source comprising the batteries and a microprocessor receiving the signals from analog/digital converters which are interconnected to the thermocouples attached to the blade of the spit. The printed circuit board also has a Bluetooth module for wirelessly transmitting the data from the microprocessor to the application installed on the smartphone.

### ADVANTAGES OF THE INVENTION

The portable rotating spit with remote monitoring of the food temperature results in the following advantages over the prior art:
have a simple flat blade which penetrates and retains the meat, enabling it to rotate integrally;
have a gearmotor assembly enabling the blade to rotate, and enabling the use of the spit in any grills;
is powered by batteries, which enables the use of the spit in places without power supply, such as in public spaces and camping sites;
have a robust and compact construction, making its transport, cleaning and storage easier, and making it effectively portable;
have temperature sensors integrated in the blade of the spit, which informs the user on the food cooking stage;
have a Bluetooth transmission module for an application installed on a smartphone, enabling a remote monitoring of the temperature, without the user being near the spit;
makes it possible to send a signal to the smartphone, alerting the user that the food has reached the set temperature.

### BRIEF DESCRIPTION OF THE DRAWINGS

The portable rotating spit with remote monitoring of food temperature is described in detail based on the attached drawings, listed below:

FIG. 1—perspective view of the portable rotating spit;

FIG. 2—exploded perspective of the portable rotating spit;

FIG. 3—perspective view showing the rotating portion of the portable rotating spit;

FIG. 4—exploded perspective showing the rotating portion of the portable rotating spit;

FIG. 5—perspective view of a constructive option of the rotating spit;

FIG. 6—exploded perspective showing the constructive option of the rotating portion of the rotating spit;

FIG. 7—perspective view showing the rotating blade assembly of the rotating spit;

FIG. 8—exploded view of the rotating blade assembly of the spit;

FIG. 9—axial view of the portable rotating spit;

FIG. 10—block diagram showing the electronic device of the rotating spit;

FIG. 11—schematic diagram of the smartphone display with the main application screen.

### DETAILED DESCRIPTION OF THE DRAWINGS

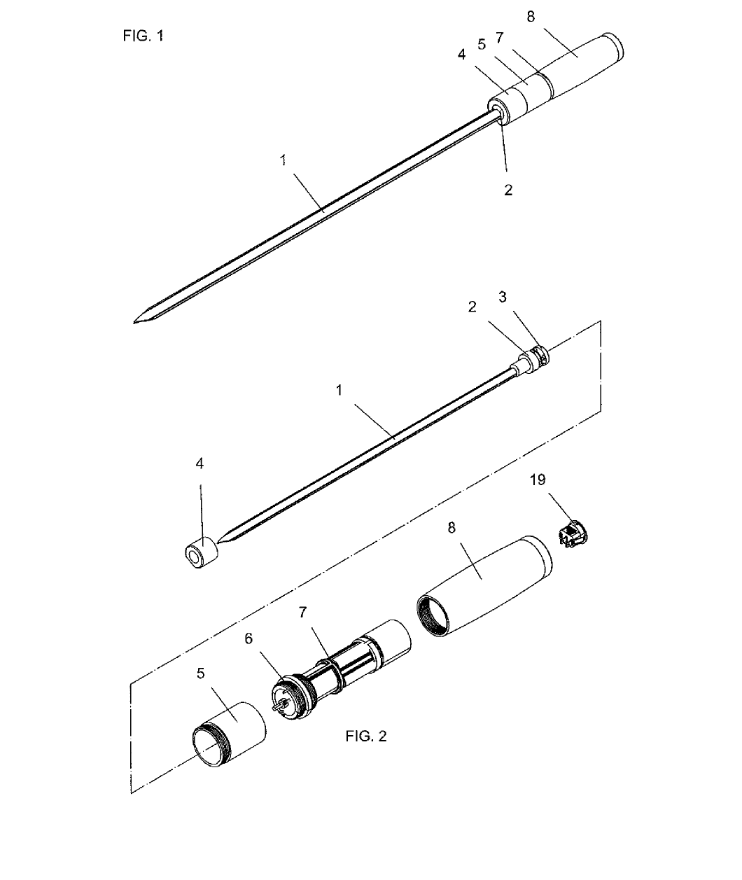

FIGS. 1 and 2 show the portable rotating spit comprising a blade (1) mounted on a cylindrical support (2) in which the electronic device (3) is installed. A bearing (4) engages the support (2) and is screwed into a ring (5) which is threaded into the thread (6) of the rotating assembly housing (7) for the blade of the spit. A cover (8) of the handle is threaded into the opposite segment of the thread (6) of the rotating assembly (7), causing the handle to become airtight. A switch (19) is positioned at the end of the handle.

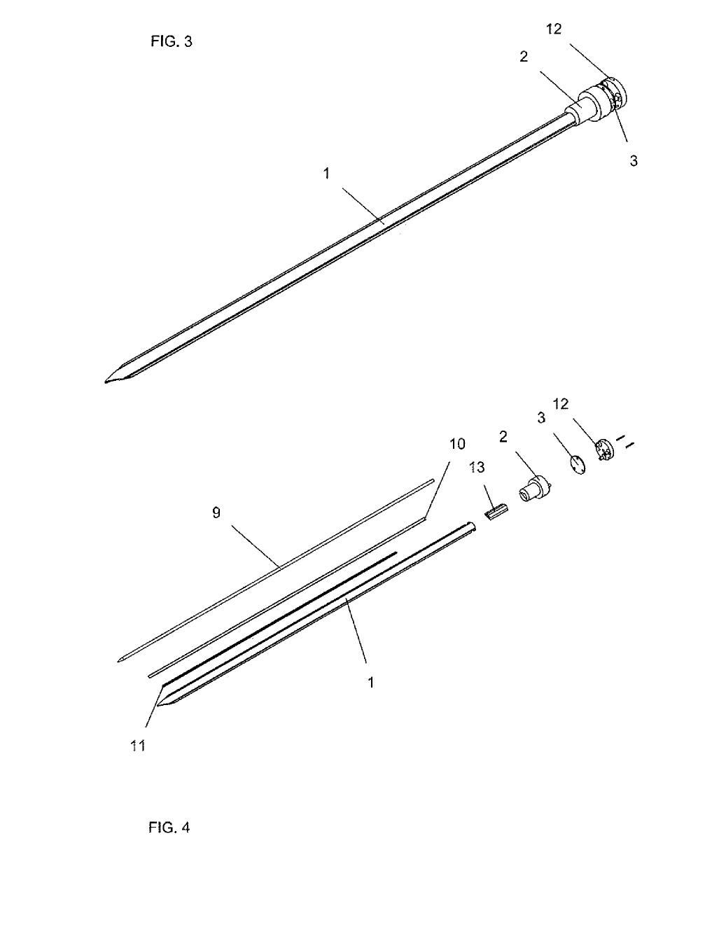

FIGS. 3 and 4 detail the rotating portion of the spit comprising the blade (1) mounted on the cylindrical support (2). The blade (1) comprises a probe (9) with a weld bead (10) and a wire pack (11) for the thermocouples which will measure the temperature stages, preferably three stages, of the food in contact with the spit. The printed circuit board of the electronic device (3) and a disc (12) with a central hole, in which the shaft of the gearmotor assembly is fitted, are attached to the support (2) (not illustrated). According to the profile of the blade (1) an adapter (13) may be required for attaching the support (2).

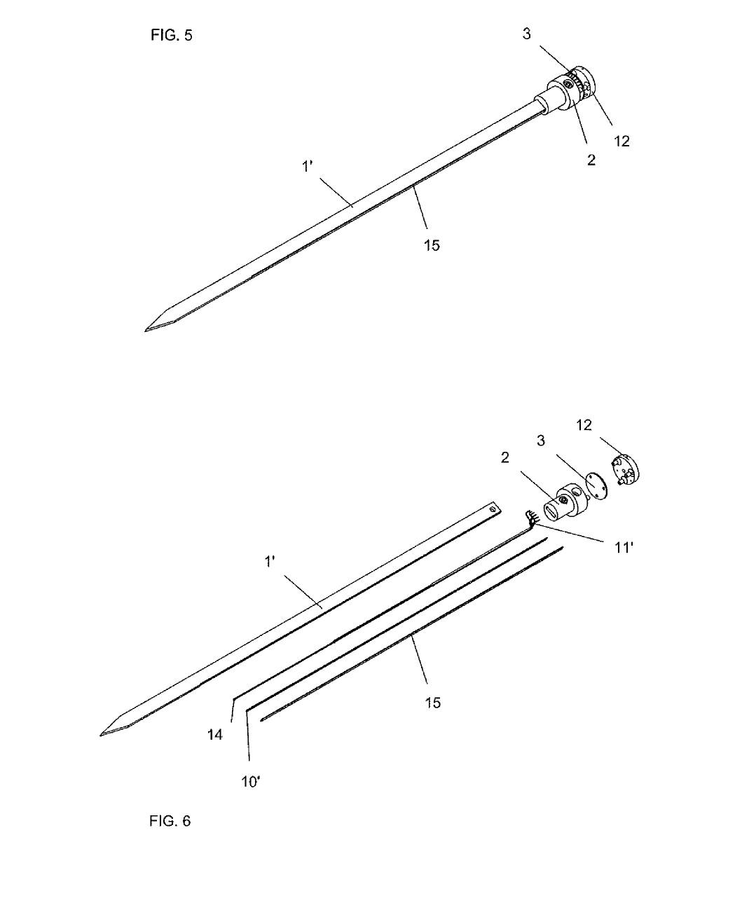

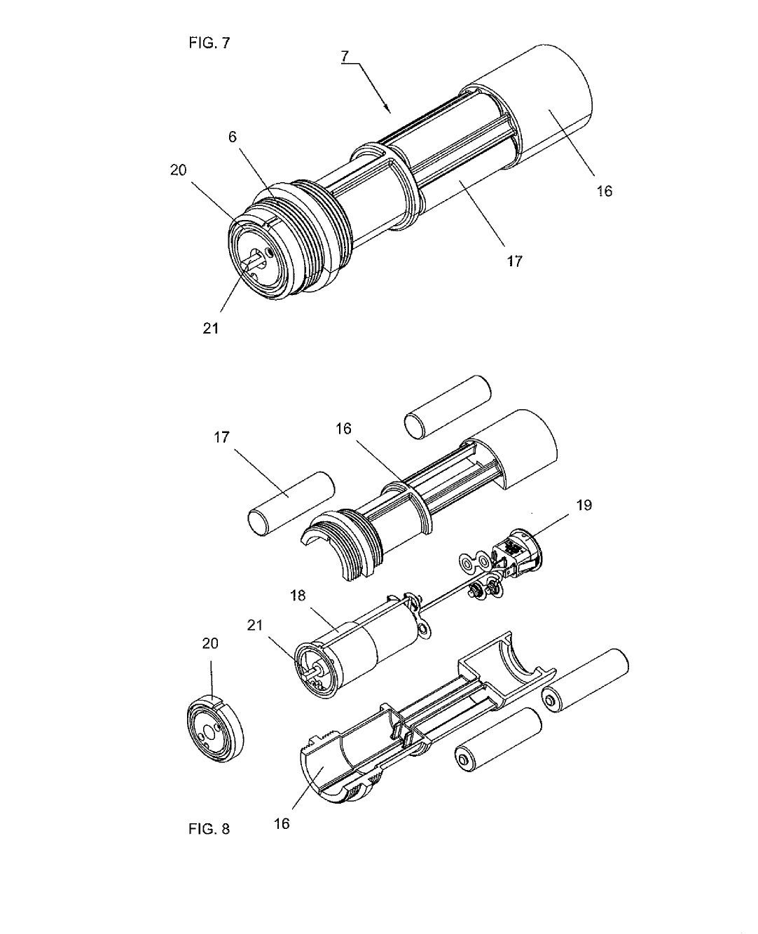

FIGS. 5 and 6 detail a constructive option of the rotating portion of the spit comprising the blade (1′), with a rectangular cross-section profile, which is mounted directly on the cylindrical support (2) without the need for an adapter. The blade comprises (1′) a wire pack (11′) for the thermocouples integrated in the blade, a wire protection (14), a weld bead (10′) and a cover and protection layer (15).

FIGS. 7 and 8 detail the rotating assembly (7) which comprises a housing (16) receiving the batteries (17), a gearmotor (18), a switch (19) and a seating thermal insulation washer (20). After the mounting, the housing (16) becomes a package which releases the shaft (21) of the electric motor.

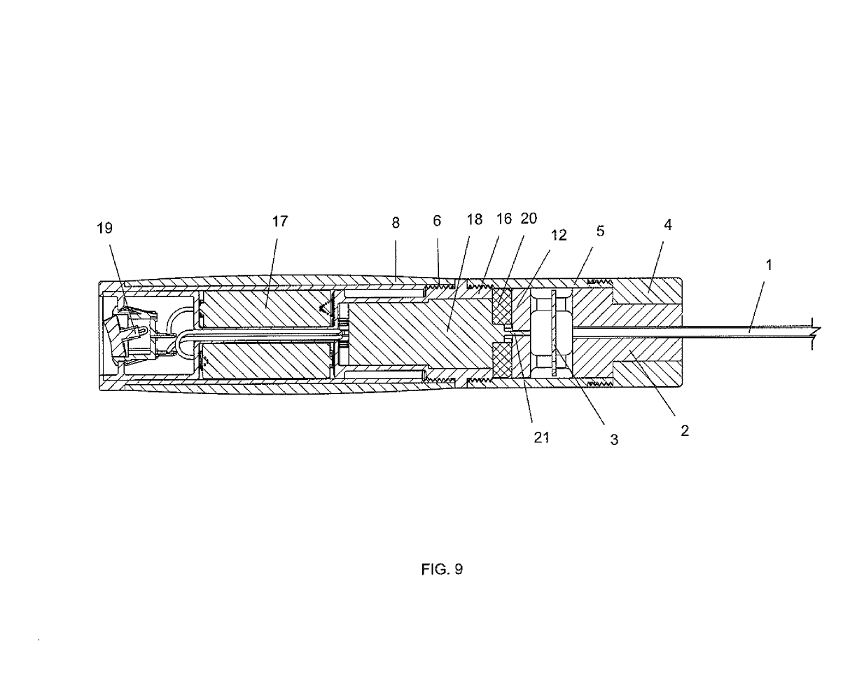

FIG. 9 details, in an axial cross-section, the mounted spit handle comprising the cylindrical support (2) with the mounted blade (1) in which the printed circuit board of the electronic device (3) is attached, the bearing (4) whose inner side rotatably slides the support (2) and which is screwed into the ring (5) threaded into the thread (6) of the housing (16) for the blade rotating assembly. The (16) receives the batteries (17), the gearmotor (18), the switch (19), the seating thermal insulation washer (20), the disk (12) for torque transmission of the motor shaft (21) for the support (2) of the blade (1) and the cover (8) which envelopes the handle assembly of the spit.

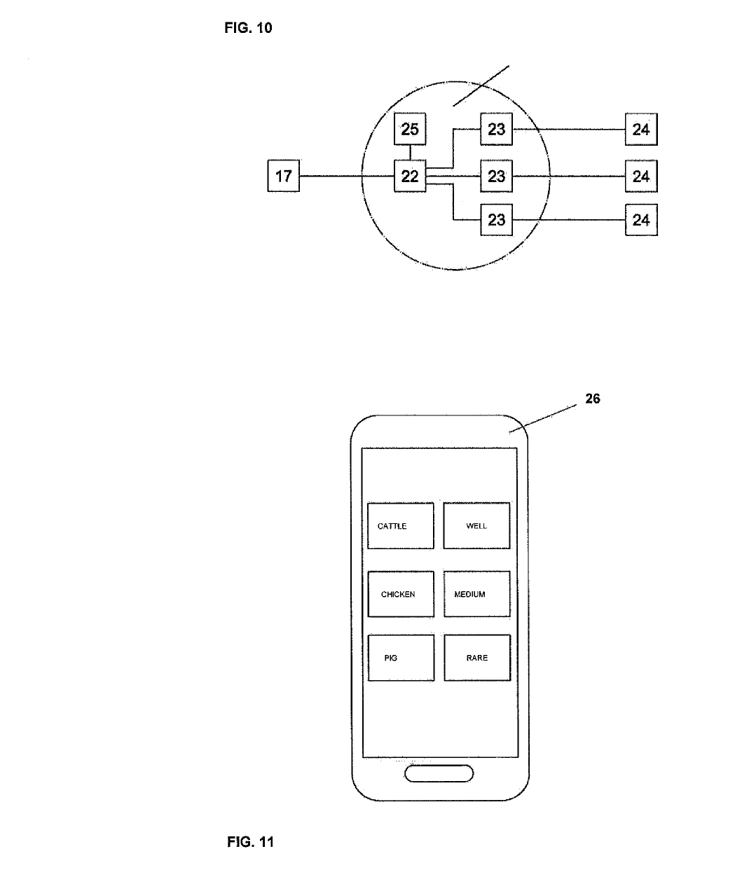

FIGS. 10 and 11 show the electronic device (3) comprising the printed circuit board with the following components: an electric source composed of the batteries (17), a microprocessor (22) receiving the signals from analog/digital converter (23) which are interconnected to the thermocouples (24) of the blade of the spit and a Bluetooth module (25) for wirelessly transmitting the data from the microprocessor (22) to the application installed on the smartphone (26).

What is claimed is:

1. A portable rotating spit with remote temperature monitoring comprising having a rotating assembly positioned inside the handle and temperature sensors positioned on the blade, comprising:
a rotating portion comprising a blade mounted on a cylindrical support, the blade being integrated in a probe with a weld bead and a wire pack for the thermocouples, and a support in which a printed circuit board of the electronic device and a disc with a central hole for inserting the shaft of the gearmotor are attached;
a stationary portion comprising a bearing engaging the cylindrical support of the blade and which is threaded into a ring threaded into the thread of the housing receiving the rotating assembly and a cover of the handle which is threaded into the opposite segment of the thread of the housing of the rotation assembly.

2. The portable rotating spit with remote temperature monitoring according to claim 1, having, optionally, an adapter to attach the blade to cylindrical support.

3. The portable rotating spit with remote temperature monitoring according to claim 1, defined as being, optionally, the blade in a rectangular cross-section profile, which is mounted directly on the cylindrical support; and, integrated in this blade, a wire pack for the thermocouples, a wire protection, a weld bead and a cover and protection layer.

4. The portable rotating spit with remote temperature monitoring according to claim 1, further comprising the rotating assembly of the blade, a housing receiving the batteries, a gearmotor, a switch and a seating thermal insulation washer; and the motor shaft engaging the hole in the disc attached to the support of the blade of the spit.

5. The portable rotating spit with remote temperature monitoring according to claim 1, defined as an electronic device mounted on the printed circuit board having an electrical source composed of the batteries, a microprocessor which receives the signals from analog/digital converters interconnected to the thermocouples attached to the blade of the spit and a Bluetooth module for wirelessly transmitting the data from the microprocessor to the application installed on the smartphone.
